(19) United States
(12) Patent Application Publication
(10) Pub. No.: US 2005/0175739 A1
(43) Pub. Date: Aug. 11, 2005

(54) Baked goods for preparing in the microwave

(75) Inventors: Hans-Werner Solbach, Geseke (DE); Hans-Wilhelm Beckmann, Bielefeld (DE)

Correspondence Address: VENABLE LLP, P.O. BOX 34385, WASHINGTON, DC, 20045-9998, US

(73) Assignee: Dr. August Oetker Nahrungsmittel KG, Bielefeld (DE)

(21) Appl. No.: 11/048,696

(22) Filed: Feb. 3, 2005

(30) Foreign Application Priority Data
Feb. 8, 2004 (DE) 10 2004 006 744.9

(51) Int. Cl. A23G 3/00

(52) U.S. Cl. 426/94

(57) ABSTRACT

The present invention relates to a baked good, characterized in that it comprises at least four layers, wherein the bottom layer consists of dough having a thickness of approximately 2-7 mm, the second layer includes a fat preparation or emulsion and wherein both layers jointly expand to a thickness of approximately 10-38 mm, preferably approximately 16-32 mm, as a result of leavening agents and a baking operation, a third layer includes a liquid to intrinsically viscous ingredient and a thereon deposited fourth layer which includes toppings generally used on baked goods, such as vegetables, fruits, cocoa products, meat constituents, cheese, seeds, spices, herbs, and the like, as well as mixtures thereof. The finished baked good is then provided with a suitable baking foundation.

### BACKGROUND OF THE INVENTION

The invention relates to baked products which the consumer can prepare quickly in the microwave oven and which have a crispy bottom as well as a soft but not tough top crust.

One characteristic that is important to the consumer is the easy preparation of the food item, wherein the quality of the completely prepared product plays a role in whether the consumer will buy it again. The use of microwave ovens for heating up food items is widespread nowadays because it is the fastest method for preparing hot foods.

Microwaves are electromagnetic waves with a wavelength in the centimeter range (1 mm-30 cm). The microwaves used for heating up a food item have a frequency that causes the water molecules in the food items to rotate (approx. 2.5 GHz), wherein the rotation heat is subsequently transmitted to the complete food item. However, heating up products with a considerable share of dough is problematic.

The microwave radiation should be effective only long enough to prevent the item from being heated completely since this would result in a soft structure. A longer effective time for the radiation results in a retrogradation of the starch which manifests itself in increasing toughness and thus a reduction in the quality of the finished baked good. The effect of microwave radiation furthermore leads to a transfer of moisture from the inside of the product to its surface, so that the surface is either moist or dried out.

Several patents deal with the process of reducing these negative results by using the effects of substances added to the dough.

European Patent 848908 describes a pulverized emulsion which is added to a dough mixture, wherein the emulsion is mixed in prior to the heating in the microwave oven. Emulsions of this type, however, do not prevent a baked product from becoming tough since they do little to change the heating processes in the microwave oven. In particular the occurrence of moisture on the surface of the baked product is not avoided.

Prior art furthermore discloses emulsions with widely varying compositions which are deposited onto the baked goods (U.S. Pat. No. 5,362,504, U.S. Pat. No. 5,089,278, U.S. Pat. No. 5,196,219). Reference EP 829206 discloses an oil-in-water micro-emulsion with a droplet size of 0.01 to 0.5 μm. However, the application of such an emulsion only results in a limited crispiness of the food item.

### SUMMARY OF THE INVENTION

It is the object of the present invention to create a baked good for a microwave oven which is easy to prepare and has similar physical and organoleptic characteristics, in particular a crispy composition, as baked goods heated up in a conventional oven.

The surprising discovery of the present invention was that a special geometric composition of the baked good makes it possible to eliminate the factors which negatively influence the quality during the heating in the microwave oven. Thus, a baked good with a crispy bottom and an elastic but not tough top is obtained without having to add special baking admixtures for the purpose of preventing the retrogradation of the starch.

### DETAILED DESCRIPTION OF THE INVENTION

The baked good therefore requires a specific geometric composition, comprising at least the following four layers:

The bottom layer is made of dough with a layer thickness ranging from approximately 2 to 7 mm which is followed by a layer of a fat preparation, wherein these two layers reach a thickness of approximately 10-38 mm during the fermentation (rising) and baking phases. The third layer includes a sauce and the fourth layer includes the toppings generally used for baked goods, such as vegetables, fruits, cocoa products, meat constituents, cheese, seeds, spices, herbs and the like, as well as mixtures thereof, wherein the ingredients of the fourth layer can be deposited individually and in several steps.

The product is then provided with a standard baking foundation, e.g. a susceptor disk or foil, and is offered at room temperature, cooled, or frozen. The following ingredients are used, for example, for producing the baked good as defined in the main patent claim:

Approximately 50-60 parts by weight of wheat flour, 25-35 parts by weight of water, 1-10 parts by weight of yeast or baking powder, 1-1.5 parts by weight of salt, 2.0-3.0 parts by weight of sucrose, 0.8-1.3 parts by weight of wheat baking agent, 15-18 parts by weight of fat, and 0.7-0.8 parts by weight of starch are used for the dough.

The dough is then prepared with these ingredients, wherein a portion of the fat and the starch are mixed separately. The dough is shaped into a layer having a thickness ranging from approximately 2-7 mm and is placed onto a foundation for the baked good. The separately prepared mixture of fat and starch is spread uniformly onto the dough layer. If yeast is used as the leavening agent, suitable fermenting phases are taken into consideration, so that the dough can expand to a thickness of approximately 10-38 mm, preferably approximately 16-32 mm, during the fermenting and baking phases.

In alternate embodiments, the leavening agent may be baking powder, sourdough, or a chemical leavening agent. During the baking operation, the deposited second layer of a fat preparation or emulsion may penetrate the or bottom first layer of dough. The deposited second layer may be composed of a mixture of fat and/or emulsifying agents and/or thickening agents. The thickening agent may be a starch, and the fat deposited as the second layer may have a melting point higher than 25° C., preferably higher than 35° C.

Depending on the product thickness, the product composition and the desired baked good volume, the baking time ranges from 5 to 25 min at baking temperatures of 130°-150° C. Following the baking, a layer of generally used sauces is applied and this is followed by a layer composed of one or more ingredients such as vegetables, fruits, cocoa products, meat constituents, cheese, seeds, spices, herbs and the like, as well as mixtures thereof.

The third layer of sauces may be composed of intrinsically viscous liquids, sauces, or milk products, such as fresh cream or curled cream or other like products. In one embodiment, the spices and herbs of the fourth layer are initially added to the third layer before the sauces, milk products, fresh cream, curdled cream or like products are deposited.

The constituents of the fourth layer are deposited in the form of squares or cubes, for which the sum of the length, height and width does not exceed approximately 80 mm and preferably 40 mm. Once one the baked good is finished and placed on a suitable foundation, the baked good may be cut into smaller portions, thus having an open-pore structure along the dough edges. In an alternative embodiment, the cutting of the larger bake good into smaller portions may occur before the third and/or fourth layer is deposited. The finished bake good may be frozen once it is finished.

When using such a specific four-layer composition for the baked good, it was surprisingly discovered that the aforementioned negative effects relating to toughness or insufficient heating do not occur. Rather, the product has a very crispy bottom with a simultaneously delicate texture on the top.

The embodiment discussed in this specification is intended only to teach those skilled in the art the best way known to the inventors to make and use the invention. Nothing in this specification should be considered as limiting the scope of the present invention. It will be apparent to one of ordinary skill in the art that any changes and modifications can be made thereto without departing from the spirit and scope of the invention, as set forth in the appended claims.

1. A baked good for preparing in a microwave oven, characterized by having at least four layers, comprising:
a bottom layer of dough with a thickness of approximately 2-7 mm;
a second layer consisting of a fat preparation or emulsion, wherein the first and second layers expand to a thickness of approximately 10-38 mm as a result of leavening agents and a baking operation;
a third layer including a product selected from a liquid to an intrinsically viscous ingredient; and
a fourth layer selected from the group consisting of generally used baked good toppings, wherein the finished baked good is provided with a suitable baking foundation.

2. The baked good according to claim 1, wherein the first and second layers expand to approximately 16-32 mm.

3. The baked good according to claim 1, wherein the generally used baked good toppings are selected from the group comprising vegetables, fruits, cocoa products, meat constituents, cheese, seeds, spices, herbs or mixtures of the toppings selected from the group.

4. The baked good according to claim 1, wherein the leavening agent is yeast and at least one fermenting phase is provided for the volume expansion.

5. The baked good according to claim 1, wherein the leavening agent is baking powder.

6. The baked good according to claim 1, wherein the leavening agent is sourdough.

7. The baked good according to claim 1, wherein the leavening agent is a chemical leavening agent.

8. The baked good according to claim 1, wherein the deposited second layer penetrates the first layer during the baking operation.

9. The baked good according to claim 1, wherein the second layer is composed of a mixture of fat and/or emulsifying agents and/or thickening agents.

10. The baked good according to claim 9, wherein the thickening agent is starch.

11. The baked good according to claim 1, wherein the fat deposited as the second layer has a melting point higher than 25° C.

12. The baked good according to claim 1, wherein the third layer includes intrinsically viscous liquids selected from the group including sauces, milk products, fresh cream, or curdled cream.

13. The baked good according to claim 2, wherein spices and herbs are initially added to the third layer before sauces, milk products, fresh cream, curdled cream are deposited.

14. The baked good according to claim 1, wherein the fourth layer is deposited during several individual steps.

15. The baked good according to claim 1, wherein the constituents of the fourth layer are deposited in the form of squares and cubes, for which the sum of length, height and width does not exceed approximately 80 mm and preferably 40 mm.

16. The baked good according to claim 1, wherein after the baked good is finished and placed onto a foundation, the larger baked good item is cut into smaller portions, thus having an open-pore structure along the dough edges.

17. The baked good according to claim 16, wherein the cutting into smaller portions occurs before the third and/or fourth layer is deposited.

18. The baked good according to claim 16, wherein the cutting into smaller portions occurs after the third and/or fourth layer is deposited.

19. The baked good according to claim 1, wherein the product is frozen once it is finished.

20. The baked good according to claim 1, wherein the suitable baking foundation is a susceptor foil.
